(19) United States
(12) Patent Application Publication
(10) Pub. No.: US 2024/0201441 A1
(43) Pub. Date: Jun. 20, 2024

(54) MULTILEVEL RETRO-COUPLING DEVICE

(71) Applicant: COMMISSARIAT A L'ENERGIE ATOMIQUE ET AUX ENERGIES ALTERNATIVES, Paris (FR)

(72) Inventors: Kyllian MILLARD, Grenoble Cedex 09 (FR); Christophe MARTINEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/541,198

(22) Filed: Dec. 15, 2023

(30) Foreign Application Priority Data
Dec. 19, 2022 (FR) 22 13726

(51) Int. Cl. G02B 6/293

(52) U.S. Cl. CPC G02B 6/29332

(57) ABSTRACT

A multilevel retro-coupling device for an electromagnetic radiation, including at least one first level (n1) and one second level (n2) at least partially superposed, the first level including a first waveguide intended to guide a propagation of the light radiation in a first direction (s1) and the second level comprising a second waveguide intended to guide the propagation of the light radiation in a second direction (s2) opposite the first direction, the device including: a coupling portion, wherein the first and second waveguides are coupled by moving them closer to one another, such that the electromagnetic radiation is propagated from the first level (n1) to the second level (n2), and at least one reflector at an end of the coupling portion, configured to reflect the electromagnetic radiation.

### TECHNICAL FIELD

The field of the invention is that of integrated photonics. The invention particularly applies to a compact addressing device for a projector, in particular, for a retinal projector.

### PRIOR ART

One of the current challenges in the fields of application linked to integrated photonics is the ever increasing need for integration. Advances in optical telecommunications or LiDARs require still greater component densities on limited surfaces. To increase the density of photonic circuits, the most common method is to move the components closer to one another, while preventing interfering coupling. To do this, it is possible to optimise the sizing of the components or the shape of the components. It is also possible to add structures between the components, making it possible to form a barrier to the interfering coupling. FIG. 1 illustrates a conventional photonic projector architecture, comprising an addressing part a1 coupled to a projection part p1. The addressing part a1 typically comprises a plurality of waveguides 11 coming from a main waveguide, for example by means of a balanced shaft of multimode interferometers (MMI). The projection part p1 typically comprises a dense waveguide distribution (4096 guides in FIG. 1 which cannot be seen individually) made of silicon nitride (Si₃N₄) with a rectangular cross-section, spaced apart regularly. Such a photonic architecture occupies a significant surface of the chip or of the substrate. In particular, the addressing part a1 has a significant surface with respect to that of the projection part p1.

There is therefore a need consisting of decreasing the bulk of such photonic architectures, so as to free up the surface to be able to further integrate components and/or densify the photonic systems. An aim of the invention is to respond to this need.

In particular, an aim of the invention is a multilevel retro-propagation device making it possible to superpose different levels of waveguides, for example an addressing level and a projection level. Another aim of the invention is an integrated projector comprising a superposed addressing level and a superposed projection level.

Other aims, features and advantages of the present invention will appear upon examining the description below and the accompanying drawings. It is understood that other advantages can be incorporated.

### SUMMARY

To achieve this aim, according to an embodiment, a multilevel retro-coupling device for a light radiation, comprising at least one first level extending along a first plane and a second level extending along a second plane parallel to the first plane, said first and second levels being at least partially superposed in a direction normal to the first and second planes, the first level comprising at least one first waveguide intended to guide a propagation of the light radiation in a first direction and the second level comprising at least one second waveguide intended to guide the propagation of the light radiation in a second direction opposite the first direction.

Advantageously, the device comprises:
a coupling portion, wherein the first and second waveguides are coupled by moving them closer to one another, such that the electromagnetic radiation, is propagated from the first level to the second level, and
at least one reflector at an end of the coupling portion, configured to reflect the electromagnetic radiation.

This makes it possible to superpose at least two levels comprising waveguides. The conventional photonic projector architecture illustrated in FIG. 1 can thus be “folded” as illustrated in FIG. 2. The projection level p2 located on the second level is, in this case, superposed at the addressing level a1 located on the first level. In FIG. 2, the light radiation is propagated from the left to the right in the addressing level a1; it is coupled at the projection level p2 in the coupling region 3, and reflected by the reflector 4; the light radiation is propagated from the right to the left in the projection level p2.

The multilevel retro-coupling device has a significantly improved compactness. This advantageously makes it possible to decrease the bulk of a photonic architecture comprising such a multilevel retro-coupling device.

Another aspect of the invention relates to an optical projection system comprising a multilevel retro-coupling device such as described above, wherein the second level corresponds to a projection level. Such a system further comprises an electrode below the projection level. This electrode, called lower electrode, typically serves to activate extraction elements on the surface of the device. The activation can, in particular, be done, by the association of a counter-electrode transferred with a component disposed above the optical projection system. The activation is done, for example, with a liquid crystal layer located 30 between the lower electrode and the counter-electrode. This makes it possible to extract some of the light radiation guided in the waveguides of the projection level, in particular, during the application of an electric voltage between the lower electrode and the counter-electrode, with the aim of emitting light points and of displaying an image.

### BRIEF DESCRIPTION OF THE FIGURES

The aims, objectives, as well as the features and advantages of the invention will best emerge from the detailed description of an embodiment of the latter, which is illustrated by the following accompanying drawings, wherein:

FIG. 1 illustrates a conventional photonic projector architecture, according to the prior art.

FIG. 2 illustrates a photonic projector architecture, according to an embodiment of the present invention.

FIGS. 3A and 3B schematically illustrate a multilevel retro-coupling device according to an embodiment of the present invention, respectively as a top view and as a cross-sectional view.

FIG. 4A schematically illustrates as a top view, a multilevel retro-coupling device according to another embodiment of the present invention.

FIGS. 4B, 4C and 4D illustrates simulation results of a propagation of a light radiation in the multilevel retro-coupling device illustrated in FIG. 4A, respectively in a plane xy1 of the first level n1, in a plane xy2 of the second level n2, and in a transverse plane xz.

FIGS. 5A and 5B schematically illustrate two variants of reflectors formed by Bragg mirrors, according to the embodiments of the present invention.

FIG. 6 has isovalues of bandwidth (in nm) of a Bragg mirror according to the length L of the mirror (in μm) and of the index perturbation Δn.

FIG. 7 schematically illustrates, as a top view, a multilevel retro-coupling device according to another embodiment of the present invention.

FIGS. 8 to 12 illustrate retro-coupling ratio curves for the device illustrated in FIG. 7, according to the coupling length and to the approximation distance ds.

FIG. 13 illustrates the optical losses by absorption induced by an IDO layer according to the gap between said ITO layer and a waveguide.

FIGS. 14A and 14B schematically illustrate the positioning of an electrode in an optical system comprising a multilevel retro-coupling device, according to an embodiment of the present invention.

FIGS. 15A and 15B schematically illustrate the positioning of an electrode in an optical system comprising a multilevel retro-coupling device, according to another embodiment of the present invention.

FIGS. 16A and 16B schematically illustrate the positioning of an electrode in an optical system comprising a multilevel retro-coupling device, according to another embodiment of the present invention.

FIG. 17 illustrates a photonic projector architecture, according to an embodiment of the present invention.

FIG. 18 illustrates a so-called RGB multilevel retro-coupling device, comprising sublevels dedicated to light radiations of different wavelengths, according to an embodiment of the present invention.

FIGS. 19A and 19B schematically illustrate an RGB multilevel retro-coupling device according to an embodiment of the present invention, respectively as a top view and as a cross-sectional view.

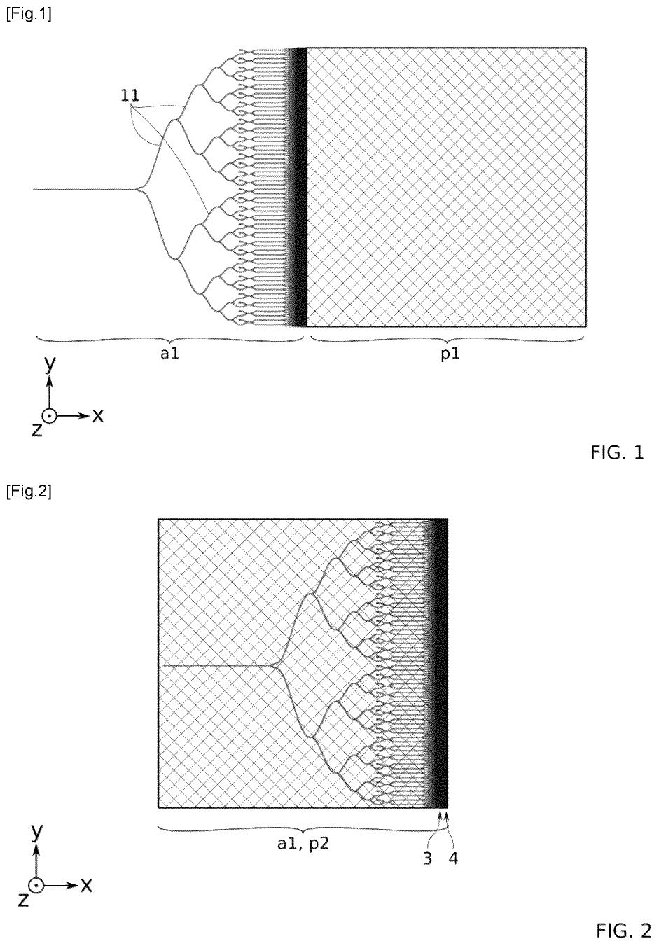

The drawings are given as examples and are not limiting of the invention. They constitute principle schematic representations intended to facilitate the understanding of the invention and are not necessarily to the scale of practical applications. In particular, on the principle diagrams, the thicknesses and/or dimensions of the different layers, patterns and raised parts are not necessarily representative of reality.

### DETAILED DESCRIPTION

Before starting a detailed review of embodiments of the invention, optional features are stated below, which can optionally be used in association or alternatively:

According to an example, the reflector is formed by an interruption of the first and second waveguides in a plane normal to the first and second propagation directions.

According to an example, the reflector is formed by a block interrupting the first and second waveguides, said block being based on a reflective material, such as aluminium. Such a reflector is not selective in wavelengths. It is advantageously broadband. Such a reflector can therefore be used for a large number of applications, for example, in the visible and in the infrared.

According to an example, the block is formed by a metal layer deposited on the surface of a plane which cuts the first and second waveguides perpendicularly to the propagation direction. This can be done by making a trench, a wall of which forms this plane. This trench which has the shape of a cavity is typically covered by a metal layer by deposition, typically between 30 and 200 nm of aluminium. The cavity is not necessarily filled with metal. The metal layer on the wall of the cavity has a thickness, typically of between 30 and 200 nm. This makes it possible to obtain a good reflectivity for the reflective block. According to another example, the block is formed from the following steps:
Cutting the device at the end of the coupling portion,
Polishing this end,
Performing a metal deposition on this end.

According to an example, the coupling portion has a length Lc/2 in a propagation direction of the electromagnetic radiation, Lc being the characteristic coupling length for a transfer of a propagation mode of the electromagnetic radiation of the first waveguide to the second waveguide. Thus, the coupling portion is folded on itself, thanks to the reflector and has a length which advantageously corresponds to half the characteristic coupling length. The coupling is thus more compact.

According to an example, the reflector is formed by a first Bragg mirror coupled to the first waveguide and by a second Bragg mirror coupled to the second waveguide, said first and second Bragg mirrors being superposed in the normal direction. Such a reflector can be easily manufactured by microelectronic methods and technologies. It is also selective in wavelengths. This makes it possible, for example, to filter light radiations and/or to create sublevels dedicated to light radiations of different wavelengths.

According to an example, the coupling portion has a length Lc/2−δ in a propagation direction of the electromagnetic radiation, Lc being the characteristic coupling length for a transfer of a propagation mode of the electromagnetic radiation of the first waveguide to the second waveguide, and δ>0 being a penetration length of the mode in the first and second Bragg mirrors. The length of the coupling portion is, in this case, decreased, due to the penetration of the propagation mode in the Bragg mirror(s).

According to an example, the first level corresponds to an addressing level and the lower electrode is located below the addressing level. This makes it possible to limit or remove the absorption phenomena linked to the lower electrode.

According to an example, the first level corresponds to an addressing level and the lower electrode is located between the projection level and the addressing level. This makes it possible to move the lower electrode of the projection level closer. This makes it possible to decrease the voltage to be applied to extract the light radiation.

According to an example, the first level corresponds to an intermediate level and the lower electrode is located at the same level as the intermediate level, and the system further comprises an addressing level located below the lower electrode and the intermediate level.

This makes it possible to decrease the optical losses while decreasing the voltage to be applied to extract the light radiation. Resorting to an intermediate level between the addressing level and the projection level further makes it possible to optimise the coupling and to reduce the length of the coupling portion.

According to an example, the at least one first level comprises a first addressing level comprising waveguides configured to guide a propagation of a first light radiation having a first wavelength λ1, a second addressing level comprising waveguides configured to guide a propagation of a second light radiation having a second wavelength λ2, a third addressing level comprising waveguides configured to guide a propagation of a third light radiation having a third wavelength λ3. This makes it possible to form, for example, an RGB (Red Green Blue) multilevel retro-coupling device or an RGB projector.

According to an example, the projection level comprises waveguides configured to respectively guide the propagations of the first, second and third light radiations. The projection is thus made from one single and same level. According to an example, the first, second and third addressing levels are located at different depths dp1, dp2, dp3 with respect to the projection level in the normal direction. This makes it possible to optimise the propagation of the light radiations of different wavelengths, by limiting the optical losses by intersection between the different levels.

According to an example, λ3>λ2>λ1, and dp3 >dp2 >dp1.

According to an example, the reflector comprises at least one first Bragg mirror configured to reflect the first wavelength λ1, at least one second Bragg mirror configured to reflect the second wavelength λ2, and at least one third Bragg mirror configured to reflect the third wavelength λ3, said first, second and third Bragg mirrors being located at one same depth dp0 with respect to the projection level in the normal direction.

According to an example, the waveguides of the first, second and third addressing levels are optically connected to the first, second and third Bragg mirrors by at least one guide portion of intermediate depth dpmi (i=1 . . . 3) such that dp3<dpmi≤dp0.

According to an example, the waveguides of the first addressing level are coupled to the at least one first Bragg mirror without a guide portion of intermediate depth and dp1=dp0, the waveguides of the second addressing level are connected to the at least one second Bragg mirror by a guide portion of intermediate depth dpm1=dp0, the waveguides of the third addressing level are connected to the at least one third Bragg mirror by a guide portion of intermediate depth dp22=dp2 and by a guide portion of intermediate depth dpm3=dp0. Unless incompatible, it is understood that all of the optional features above can be combined so as to form an embodiment, which is not necessarily illustrated or described. Such an embodiment is clearly not excluded from the invention. The features and the advantages of an aspect of the invention, for example, the device or the method, can be adapted mutatis mutandis to the other aspect of the invention.

The invention is generally based on a multilevel photonic retro-coupling device. The term “retro-coupling” means the association of optical coupling functions of a propagation mode of a light radiation, typically between two waveguides located on levels of different altitude, and retro-propagation of this light radiation. The first and second waveguides each have a guiding portion, only intended to guide the light radiation, respectively in a first and a second direction. The first and second waveguides are moved closer to one another within the coupling portion, to enable the evanescent coupling between said first and second waveguides. The first and second waveguides remain distinct and separated in the coupling portion. In the sense of the present invention, an “approximation” means that the separation distance between the guides decreases, without being zero. Thus, the first and second waveguides are not parallel to one another over their entire length.

Below, the term “absorption” or its equivalents refers to the phenomenon by which the energy of an electromagnetic wave is transformed into another form of energy, for example, by thermal dissipation. In the present description, a material is considered as absorbent as soon as it absorbs at least 20% of a light radiation.

Below, the term “reflection” or its equivalents refers to the phenomenon of reemitting an incident light radiation, from an element or a surface. In the present description, an element is considered as reflective as soon as it reemits at least one part of a light radiation, this part being greater than or equal to 50%, preferably this part being greater than or equal to 80% of the incident light radiation.

It is specified that, in the scope of the present invention, the terms “on”, “surmounts”, “covers”, “underlying”, “opposite” and their equivalents do not necessarily mean “in contact with”. Thus, for example, the deposition, the transfer, the adhering, the assembly or the application of a first layer on a second layer, does not compulsorily mean that the two layers are directly in contact with one another, but means that the first layer covers at least partially the second layer, by being either directly in contact with it, or by being separated from it by at least one other layer or at least one other element.

A layer can moreover be composed of several sublayers of one same material or of different materials.

By a substrate, a film, a layer, a structural element “based on” a material A, this means a substrate, a film, a layer, a structural element comprising this material A only, or this material A and optionally other materials, for example doping elements or alloy elements.

A preferably orthonormal system, comprising the axes x, y, z is represented in the accompanying figures. When one single system is represented in one same set of figures, this system applies to all the figures of this set.

In the present patent application, the thickness, the height or the depth are taken along z. The relative terms “on”, “surmounts”, “under”, “underlying” refer to positions taken along the direction z. The length is taken along x and the width is taken along y. A “lateral” dimension corresponds to a dimension in a direction of the plane xy. By a “lateral” extension or “laterally”, this means an extension in one or more directions of the plane xy.

An element located “in vertical alignment with” or “to the right of” another element, means that these two elements are both located on one same line perpendicular to a plane, wherein a lower or upper face of a substrate mainly extends, i.e. on one same line oriented vertically in the figures, as a cross-section.

The separation distance ds is typically taken from “centre to centre”, between the central axes of the waveguides.

The terms “substantially”, “about”, “around” mean close to 10%, and preferably, close to 5%. Moreover, the terms “comprised between . . . and . . . ” and equivalents mean that the limits are inclusive, unless mentioned otherwise.

A principle of the present invention consists of implementing an optical coupling between two levels n1, n2 of different altitude along z, this coupling being combined with a reflection, so as to change the propagation direction of the light radiation. It is thus possible to stack and to superpose different photonic levels, wherein the light radiation is propagated. Typically, a second projection level p2 located at an altitude n2 can be superposed along z at a first addressing level a1 located at an altitude n1, as illustrated in FIG. 2.

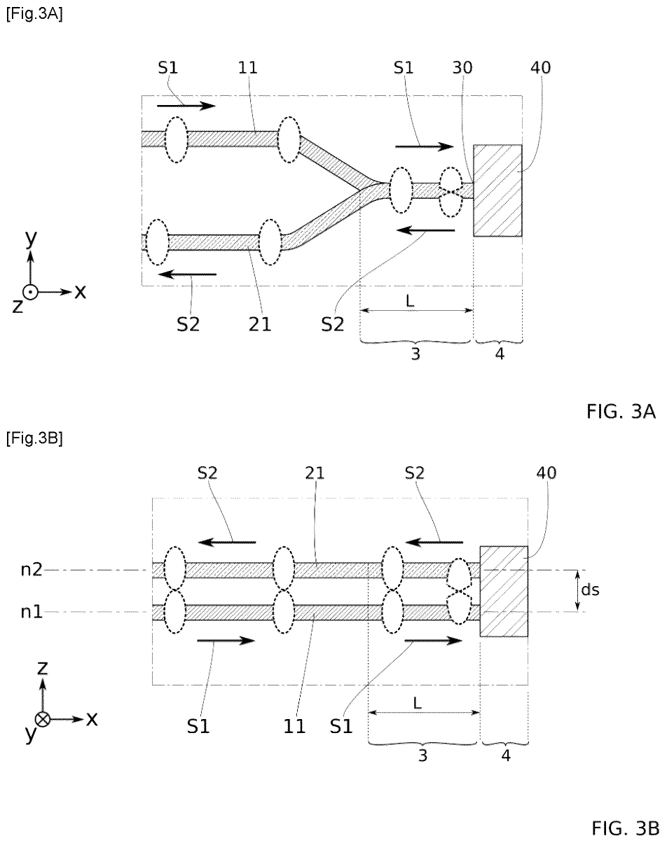

As illustrated in FIGS. 3A and 3B, the device typically comprises a first waveguide 11 configured to guide the propagation of a light radiation in a first direction s1, and a second waveguide 21 configured to guide the propagation of the light radiation in a second direction s2 opposite the first direction s1. The first waveguide 11 is located on a first level n1 having an altitude n1 along z. The second waveguide 21 is located on a second level n2 having an altitude n2 along z. The device comprises a coupling portion 3 at the level of which the first and second waveguides 11, 21 are moved closer to one another and have a minimum separation distance ds enabling an optical coupling, typically an evanescent coupling, between the first waveguide 11 and the second waveguide 21. This coupling portion 3 has a length L along x. At the end 30 of the coupling portion 3, the device further comprises a reflector 4, configured to reflect the light radiation. In the example illustrated in FIGS. 3A, 3B, the reflector 4 is formed by a layer 40 based on a reflective material, for example, made of aluminium.

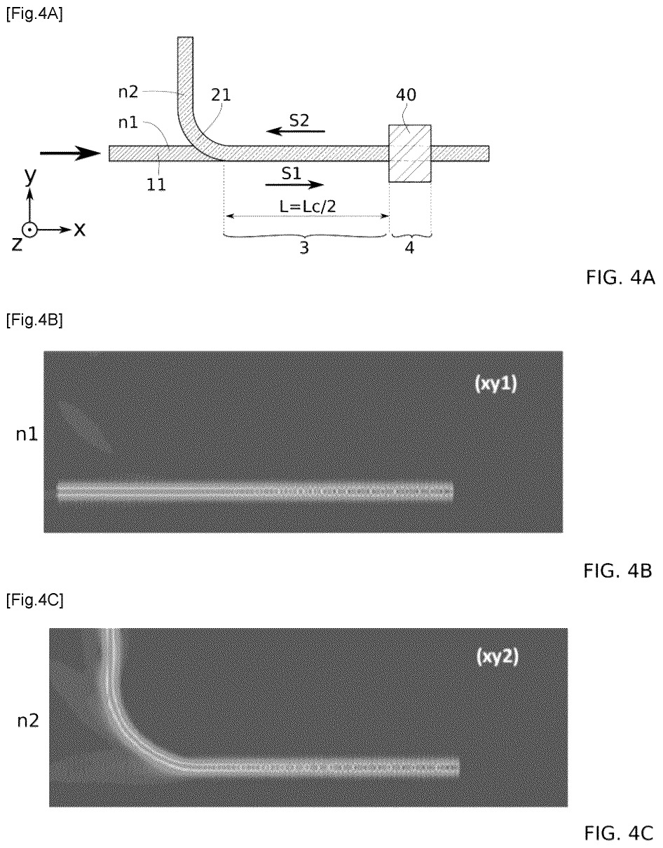

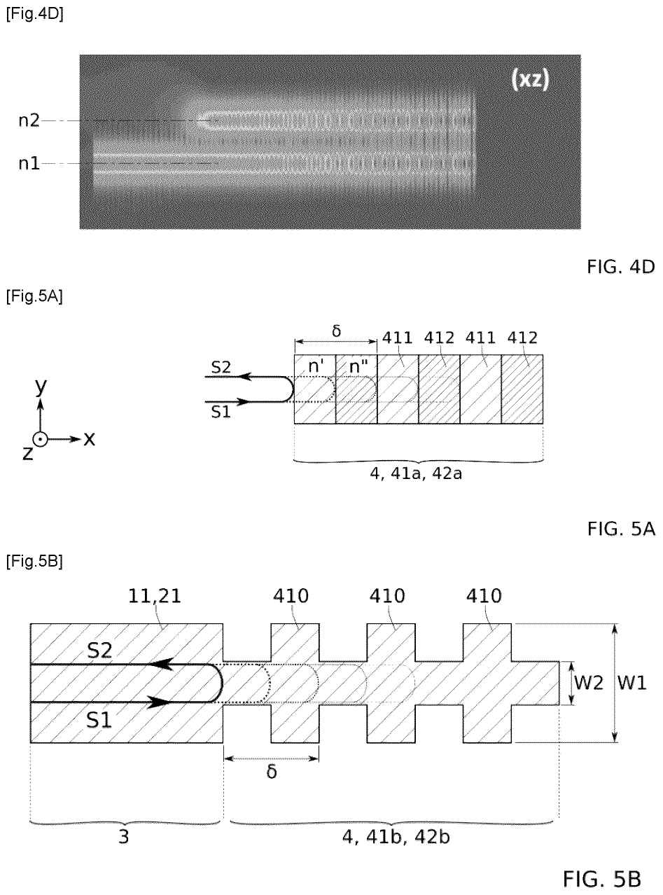

FIG. 4A illustrates an embodiment of the retro-coupling device comprising guides 11, 21 made of silicon nitride (Si₃N₄) having a refraction index n=1.97 for a light radiation of wavelength λ=532 nm. The guides 11, 21 have a width along y of 300 nm and a thickness along z of 200 nm. The guides 11, 21 are thus monomodal for the light radiation of wavelength λ=532 nm. The light radiation is thus propagated according to the fundamental optical mode within the guides 11, 21. The retro-coupling principle according to the invention can, however, be implemented for different propagation modes, for example, for secondary coupling modes.

The guides 11, 21 are superposed along z at the coupling portion 3. Along the coupling portion 3, the fundamental optical mode can be transferred from one guide 11 to the other guide 21 by evanescent coupling, if the two guides 11, 21 are sufficiently close to one another over a sufficiently long length. The “sufficiently close” distance is the minimum separation distance ds. The “sufficiently long length” is called coupling length Lc, and corresponds to the characteristic length, necessary such that a mode, typically the fundamental mode, is transferred from the first guide 11 to the second guide 21, by preserving its propagation direction, i.e. in the absence of perturbations along the guide borrowed by the light radiation. This transfer of mode without modification of the propagation direction can be conventionally done by a directional coupler. According to the approach called super-modes, the transferred mode can be seen as the combination of a symmetric mode and an antisymmetric mode on the two guides 11, 12. The coupling length is thus written:

$${L}_{c} = \frac{λ}{2 Δ n} \qquad [ Math 1 ]$$

with Δn=|n_{eff1}−n_{eff2}| which corresponds to the difference of effective indices between the symmetric and antisymmetric modes. For a separation distance ds of 550 nm between the centre of the first guide and the centre of the second guide, the coupling length Lc is around 60 μm.

In the present case, a reflector 4, in this case, a block 40 in the form of an aluminium layer of thickness 100 nm along x, interrupts the guides 11, 21 at an end of the coupling portion 3. The light radiation thus borrows the coupling portion 3 a first time in the direction s1, then a second time in the direction s2. For this embodiment, the coupling portion 3 has a length L=Lc/2. For a separation distance ds of 550 nm between the centre of the first guide and the centre of the second guide, the length L of the coupling portion 3 is therefore around 30 μm. The coupling portion 3 of this device is thus two times more compact than a conventional directional coupler.

FIGS. 4B, 4C and 4D illustrate FDTD (Finite Difference Time Domain) simulation results, obtained for a propagation of a light radiation of wavelength λ=532 nm in the device illustrated in FIG. 4A.

FIG. 4B is a simulated mapping of the electromagnetic field in a plane xy1 corresponding to the first level n1. It appears that the incident light radiation is propagated in the first guide 11 of the first level n1. FIG. 4C is a simulated mapping of the electromagnetic field in a plane xy2 corresponding to the second level n2. It appears that the reflected light radiation is propagated in the second guide 21 of the second level n2. FIG. 4D is a simulated mapping of the electromagnetic field in a transverse plane xz. It appears that the light radiation is shared between the first guide 11 and the second guide 21 at the approach of the reflector. This shows that the coupling and the retro-propagation are possible in combination.

Based on these digital simulations carried out on the device of FIG. 4A, a maximum retro-coupling of about −0.68 dB (that is about 87%) is obtained.

Such a device can be made by creating a cavity at the middle of a directional coupler and by performing a metal deposition there (of aluminium, for example, or a titanium/aluminium deposition stack).

The coupling portion 3 presented in FIG. 4A can be manufactured by conventional microelectronic methods, typically by photolithography, then by etching of an Si₃N₄ layer deposited on an oxide layer created by oxidation of a silicon substrate. A mask and a hotolithography/etching step are implemented for each guide level.

The metal mirror 40 can be made in different ways:
by etching a cavity through the guides and the oxide, then by proceeding with a metallisation to cover the wall of the cavity corresponding to the end of the coupling portion. Another photolithography mask is thus implemented to form the cavity. The latter mask does not require a large dimensional resolution. IT is therefore advantageously inexpensive;
by creating a cavity by focused ion beam (FIB);
by forming the end surface of the guides by cutting then polishing, then by depositing a metal on said surface.

The advantage of using a metal block 40 as a reflector 4 is that it is not very selective in wavelength. Such a reflector 4 can therefore be used for a large number of applications in the visible and infrared domains.

The reflector 4 can also simply consist of an interruption of the guides 11, 21 by a transverse cutting of the substrate. This cutting is done as above, by etching a cavity of cutting the chip. The refraction index contrast Δn=n_{g}−nₐ between the guiding material of the guides 11, 21 (typically n_{g}=2) and air (index nₐ=1) leads to a reflection close to 10%. This value is low for an application of the projection device type, but can be sufficient for other applications (for example, for sensors). It offers the advantage of not requiring any metal deposition and of being dependent on the surrounding medium (useful for a sensor application).

The reflector 4 can also be made by a stack of dielectric layers of different refraction indices. The layers can be made of SiO₂ and of TiO₂ with an index contrast which approaches the unit. The sizing of this stack is similar to that of the Bragg mirrors described below. The high index contrast makes it possible to highly reduce the length of the equivalent Bragg mirror, thus reducing the number of layers of the stack (typically 10). The formation of such a stack is less expensive.

FIGS. 5A and 5B illustrate alternative reflectors 4 formed by Bragg mirrors. The Bragg reflectors are very broadly used in on-silicon integrated photonics. They are easily producible by conventional microelectronic methods.

FIG. 5A illustrates a first embodiment of a Bragg mirror 41a, 42a comprising two materials 411, 412 of indices n′, n″ disposed alternately along the propagation direction of the light radiation. The interfaces between these two materials generate successive reflections of the wave which penetrates it. At each interface, a part of the wave is reflected, and the other transmitted. The propagation mode of the light radiation thus penetrates into the Bragg mirror 41a, 42a along a penetration length δ>0.

FIG. 5B illustrates a second embodiment of a Bragg mirror 41b, 42b obtained by corrugation of the flanks of a waveguide 11, 21. In this case, the sections 410 of width w1 have a first effective index and the narrow sections of width w2 have a second effective index. This makes it possible to recreate a succession of interfaces due to the succession of two different effective indices. The propagation mode of the light radiation penetrates also into the Bragg mirror 41b, 42b along a penetration length δ>0.

The penetration length δ can be evaluated according to:

$$δ = \frac{λ}{2 Δ n} arg cosh ( \sqrt{e} ) \qquad [ Math 2 ]$$

Where λ is the wavelength, and Δn is the index contrast Δn=n′−n″.

The reflectivity R of the Bragg mirror depends, in a known manner, on the force of the array κ and on the length of the array I defining the Bragg mirror, according to:

[Math3]R=tanh²κl

A reflectivity R of 99.9% corresponds to a product κl of around 4.15 rad.

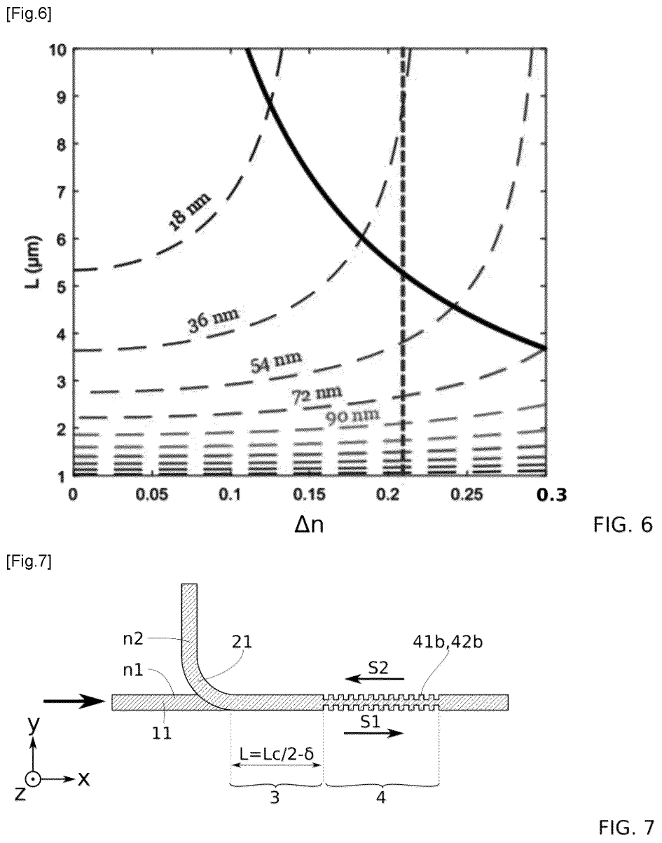

The bandwidth Δλ of the Bragg mirror also depends on these parameters κ and l. FIG. 6 illustrates different isovalue bandwidth curves (18 nm, 36 nm, 54 nm, etc.) according to the length of the array l and to the index difference Δn (κ being directly proportional to Δn). The solid line curve corresponds to the values of l and Δn giving κl=4.15 rad for a theoretical reflectivity of 99.9%.

For an index contrast Δn≈0.22 (corresponding to a waveguide made of silicon nitride encapsulated in silica) with corrugations of width w2=75 nm and of period Λ≈170 nm, a reflectivity of about 99.9% is reached for an array length l of 5.13 μm. The width of the bandwidth is estimated in this case, at around 54.5 nm.

FIG. 7 illustrates an embodiment of the retro-coupling device comprising the guides 11, 21 made of silicon nitride (Si₃N₄) having a width along y of 300 nm and a thickness along z of 200 nm, and separated by a separation distance ds of 550 nm, as above.

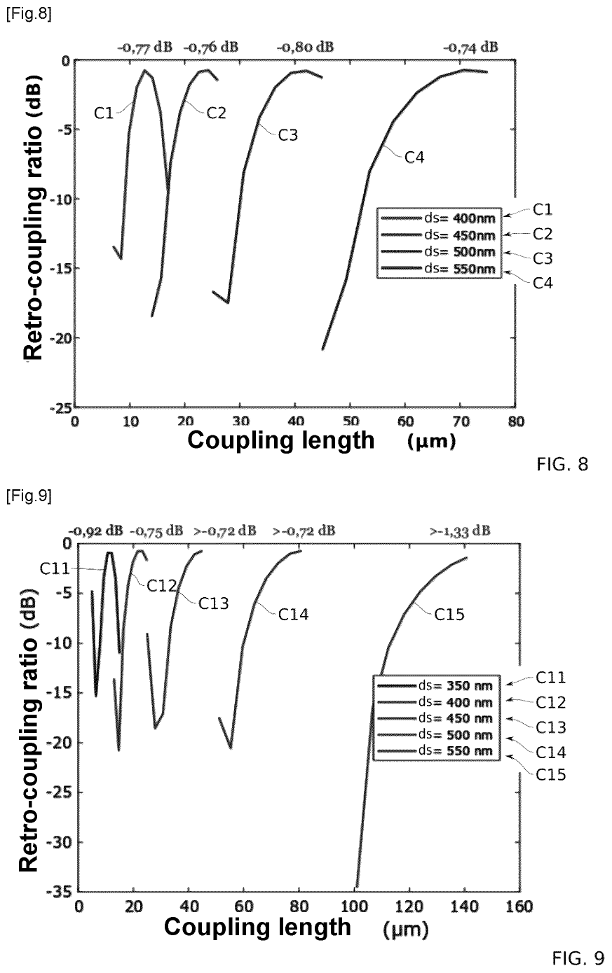

In this embodiment, the reflector 4 is formed by two superposed, identical Bragg mirrors 41b, 42b. In this case, the coupling portion 3 has a length L=Lc/2−δ which considers the penetration length δ of the light radiation in the Bragg mirrors 41b, 42b. FIG. 8 has different retro-coupled optical power curves, according to the coupling length L, for different separation distances ds and for a wavelength of 532 nm. For each curve, the second retro-coupling maximum has been retained. The curve 1 is obtained for a separation distance ds of 400 nm between the centre of the first guide and the centre of the second guide. The length L of the coupling portion 3 corresponding to the retro-coupled power maximum (−0.77 dB) is around 12 μm. The curve C2 is obtained for a separation distance ds of 450 nm. The length L of the coupling portion 3 corresponding to the retro-coupled power maximum (−0.76 dB) is around 23 μm. The curve C3 is obtained for a separation distance ds of 500 nm. The length L of the coupling portion 3 corresponding to the retro-coupled power maximum (−0.80 dB) is around 41 μm. The curve C4 is obtained for a separation distance ds of 550 nm. The length L of the coupling portion 3 corresponding to the retro-coupled power maximum (−0.74 dB) is around 70 μm.

The same type of curves is illustrated in FIGS. 9 to 12 for different wavelengths. FIG. 9 and the curves C11 . . . C15 illustrate the retro-coupled optical power, according to the coupling length L, for different separation distances ds for a wavelength of 450 nm. The curve C11 is obtained for a separation distance ds of 350 nm. The curve C12 is obtained for a separation distance ds of 400 nm. The curve C13 is obtained for a separation distance ds of 450 nm. The curve C14 is obtained for a separation distance ds of 500 nm. The curve C15 is obtained for a separation distance ds of 550 nm. The multilevel retro-coupling ratio is comprised between −1.33 dB (˜73.6%) and at least −0.72 dB (˜84.7%) at λ=450 nm.

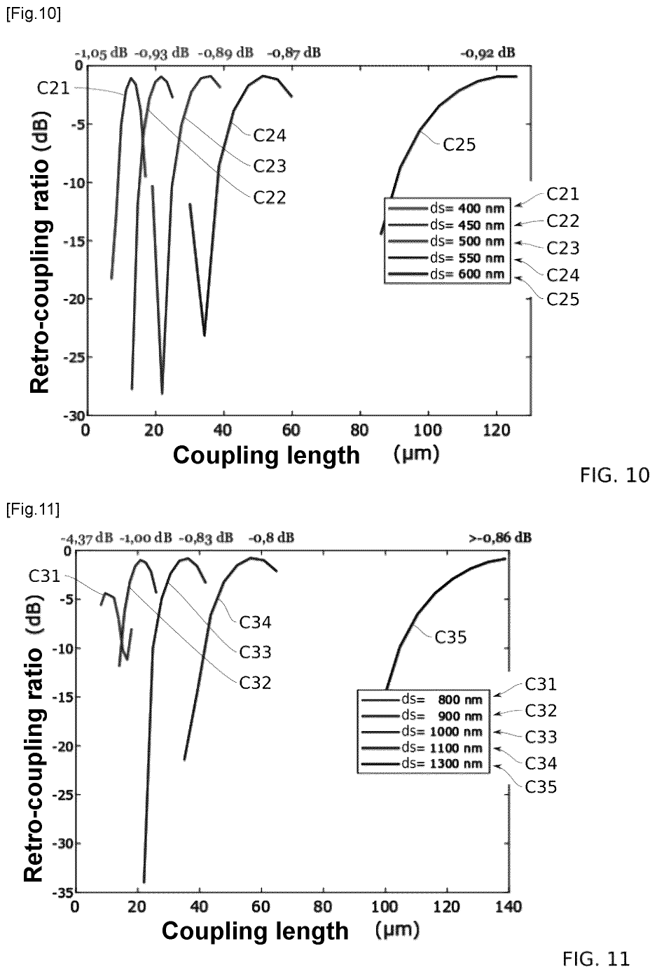

FIG. 10 and the curves C21 . . . C25 illustrates the retro-coupled optical power, according to the coupling length L, for different separation distances ds and for a wavelength of 633 nm.

The curve C21 is obtained for a separation distance ds of 400 nm. The curve C22 is obtained for a separation distance ds of 450 nm. The curve C23 is obtained for a separation distance ds of 500 nm. The curve C24 is obtained for a separation distance ds of 550 nm. The curve C25 is obtained for a separation distance ds of 600 nm. The multilevel retro-coupling ratio is comprised between −1.05 dB (˜78.5%) and −0.87 dB (˜81.9%) at λ=633 nm.

FIG. 11 and the curves C31 . . . C35 illustrate the retro-coupled optical power, according to the coupling length L, for different separation distances ds and for a wavelength of 1320 nm. The curve C31 is obtained for a separation distance ds of 800 nm. The curve C32 is obtained for a separation distance ds of 900 nm. The curve C33 is obtained for a separation distance ds of 1000 nm. The curve C34 is obtained for a separation distance ds of 1100 nm. The curve C35 is obtained for a separation distance ds of 1300 nm. The multilevel retro-coupling ratio is comprised between −4.37 dB (˜36.6%) and at least −0.83 dB (˜82.6%) at λ=1320 nm. These results are given for information. Certain values, in particular the value −4.37 dB, can be under-evaluated, in particular regarding the sampling of the different curves.

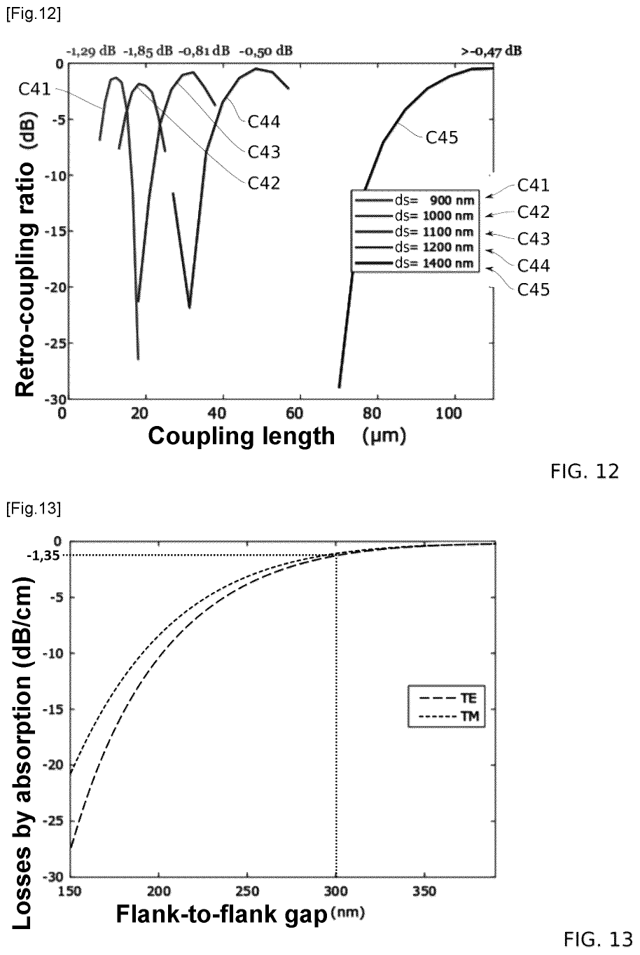

FIG. 12 and the curves C41 . . . C45 illustrate the retro-coupled optical power, according to the coupling length L, for different separation distances ds and for a wavelength of 1550 nm. The curve C41 is obtained for a separation distance ds of 900 nm. The curve C42 is obtained for a separation distance ds of 1000 nm. The curve C43 is obtained for a separation distance ds of 1100 nm. The curve C44 is obtained for a separation distance ds of 1400 nm. The multilevel retro-coupling ratio is comprised between −1.85 dB (˜36.6%) and at least −0.47 dB (˜89.7%) at λ=1550 nm.

Generally, the retro-coupling ratio tends to increase when the separation distance ds increases. Indeed, two Bragg mirrors positioned too close to one another can interact and generate optical losses. It is preferable to use relatively large distances ds, to facilitate the manufacture (robustness of the design). An imprecision on the coupling length in the design further has little impact as the ratio curves have substantially a plate at their maximum. For all the wavelengths presented, a simulated retro-coupling ratio greater than 80% can be obtained for at least one separation distance ds. The optimal results obtained by simulations are summarised in the table below:

TABLE 1

| | λ = | λ = | λ = | λ = |
|---|---|---|---|---|
| | 450 nm | 633 nm | 1320 nm | 1550 nm |
| distance ds (nm) | 450 | 550 | 1000 | 1200 |
| coupling length L (μm) | 45 | 51.4 | 36.3 | 48.4 |
| retro-coupling ratio (dB) | −0.72 | −0.87 | −0.83 | −0.5 |

The monomodal waveguides and the Bragg mirrors are typically resized for each wavelength. The optimised Bragg mirrors (R=99.9%) at the wavelengths 450 nm, 633 nm, 1320 nm and 1550 nm typically have the parameters grouped together in the table below:

TABLE 2

| λ (nm) | 450 | 633 | 1320 | 1550 |
|---|---|---|---|---|
| Thickness (nm) | 200 | 200 | 500 | 600 |
| Width w1 (nm) | 220 | 400 | 750 | 900 |
| Period Λ (nm) | 143 | 204 | 420 | 490 |
| Length l (μm) | 4.4 | 6.4 | 12.0 | 13.8 |
| Width w2 (nm) | 55 | 100 | 260 | 330 |
| Estimated Δλ (nm) | 45.6 | 62.4 | 143.3 | 171.9 |

It is possible to also optimise the Bragg mirrors by increasing the force of the array. Increasing the force of the array makes it possible to increase the reflectivity of the Bragg mirror and to expand the bandwidth, which makes the Bragg mirror even more robust in wavelength.

The multilevel retro-coupling device can be advantageously implemented in the scope of an optical projection system, for example, an integrated display unit for retinal projection. To produce such a projection system, a projection level is superposed at an addressing level. The projection level corresponds, in this case, to the second level of the multilevel retro-coupling device, and the addressing level corresponds to the first level of the multilevel retro-coupling device. To extract the light from the projection level, the system further comprises an electrode below the projection level, called lower electrode. This lower electrode is typically associated with a counter-electrode or upper electrode, generally in the form of a gate, transferred by a second device, for example with liquid crystals.

The lower electrode and/or the counter-electrode are preferably indium tin oxide (ITO)-based. The lower electrode is typically positioned, neither too far from the counter-electrode gate to avoid too high, nor too close drops in potential of the counter-electrode gate to avoid optical losses by absorption. To evaluate the optical losses linked to the position of the lower electrode, it will be considered that an ITO-based electrode located at 300 nm from a waveguide induces a loss by absorption of −1.35 dB/cm. These losses decrease exponentially when the gap between the ITO layer and the waveguide increases, as illustrated in FIG. 13.

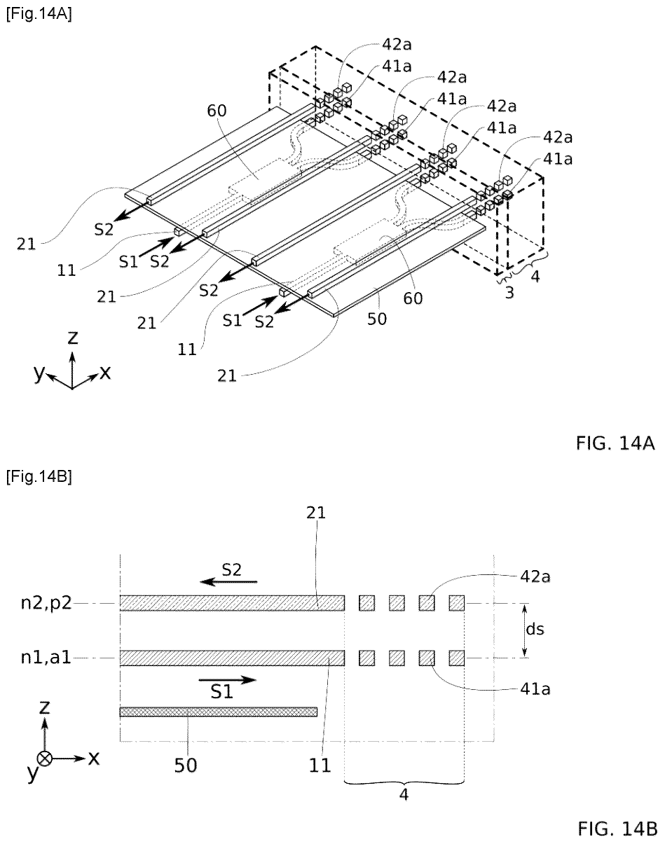

FIGS. 14A, 14B illustrate a first embodiment of the projection system, wherein the lower electrode 50 is positioned under the second projection p2 level n2 and under the first addressing a1 level n1. This makes it possible to limit or remove the optical losses by absorption within the ITO.

The addressing level a1 comprises waveguides 11 typically subdivided by way of multimodal interferometers MMI 60. According to an example, the light radiation is thus distributed in a balanced manner, over a total of 4096 guides. The waveguides 11 open onto Bragg reflectors 41a. The projection level p2 comprises waveguides 21 partially in vertical alignment with the waveguides 11 in the coupling portion 3. The waveguides 21 are coupled to Bragg reflectors 42a. The Bragg reflectors 42a are superposed along z to the Bragg reflectors 41a. When the light radiation is injected into the waveguides 11 in the direction of the Bragg reflectors 41a, in the direction S1, it is reflected and injected by coupling in the waveguides 21, in the direction S2 opposite S1. It is then extracted from the projection level, by applying a voltage between the extraction electrodes, i.e. between the lower electrode and the upper electrode. By superposing the addressing and projection levels, this projection system is advantageously compact. The first embodiment of the projection system typically makes it possible to limit the optical losses.

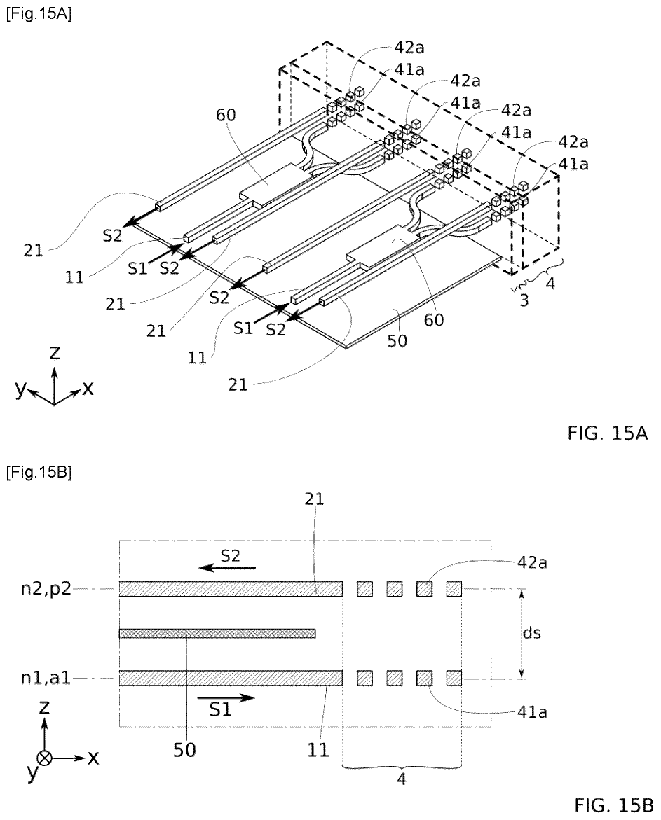

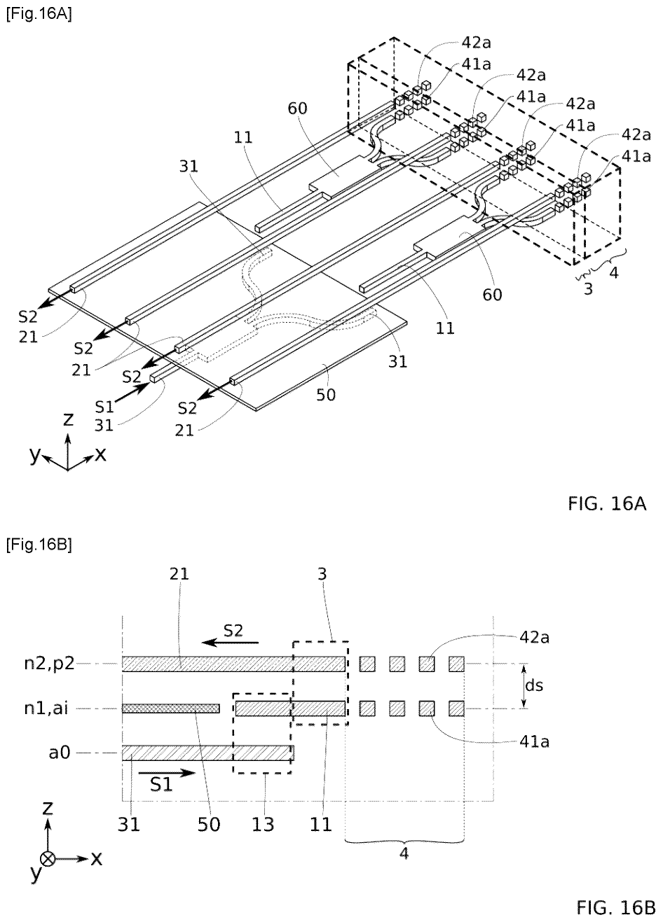

The more the distance between the two extraction electrodes increases, the more the voltage to be applied to extract the light radiation increases. This affects the energy efficiency of an integrated projector. The embodiments of the projection system illustrated in FIGS. 15A, 15B and 16A, 16B aim to decrease the voltage necessary to be applied on the electrodes to extract the light radiation. The elements described and referenced for the first embodiment are also transposable to the two embodiments below.

FIGS. 15A, 15B illustrate a second embodiment of the projection system, wherein the lower electrode 50 is positioned between the second projection p2 level n2 and the first addressing a1 level n1. This makes it possible to move the lower electrode 50 closer to the surface of the projector in the vicinity of which the counter-electrode is located. The extraction voltage is thus decreased. To limit the optical losses by absorption due to the lower electrode 50, the separation distance ds between the first and second levels n1, n2 is increased. According to an example, ds≥850 nm. The coupling length of the coupling portion 3 is consequently increased. This affects the compactness of the system. The second embodiment of the projection system typically enables a moderate electric consumption.

FIGS. 16A, 16B illustrate a third embodiment of the projection system, wherein the lower electrode 50 is positioned at the same level as an intermediate level n1 referenced ai. The lower electrode 50 is positioned above an addressing level a0, and below the projection level p2. In this embodiment, the addressing level a0 comprises waveguides 31 without reflectors. The intermediate level ai comprises waveguides 11 opening onto Bragg reflectors 41a. The projection level p2 comprises waveguides 12 coupled to Bragg reflectors 42a. The light radiation is, in this case, injected into the waveguides 31 of the addressing level a0, in the direction S1. It is then injected by coupling 13 in the waveguides 11, in the direction S1. It is then reflected and injected by coupling in the waveguides 21, in the direction S2 as above. It is then extracted from the projection level by applying a voltage between the extraction electrodes.

The intermediate level ai makes it possible to form an optical bridge between the addressing level a0 and the projection level p2. The separation distance ds can, for example, be reduced to 450 nm. This makes it possible to drastically reduce the length of the coupling portions 13, 3. A simulation by FDE (Finite Difference Eigenmode)-specific modes of finite elements indicates that a coupling length Lc for the coupling portion 3 of around 20.6 μm is suitable. The compactness of the system is preserved. Thanks to the intermediate level ai, the guides 31 can be moved away from the lower electrode 50. This makes it possible to limit or remove the optical losses by absorption. The guides 31 are also relatively farther away from the guides 21. This makes it possible to limit or remove the optical losses by multilevel intersections. The optical losses for this third embodiment are comparable to those induced in the first embodiment. The extraction voltage is further decreased with this electrode 50 positioning, with respect to the first embodiment. The third embodiment of the projection system is a good compromise making it possible to combine low optical losses and a moderate electric consumption. Its implementation is more expensive than the implementations of the first and second embodiments. In FIGS. 16A, 16B, the Bragg mirrors 41a, 42a are associated respectively with the intermediate level ai and with the projection level p2. Other associations or configurations can be considered. The Bragg mirrors 41a, 42a can, in particular, be associated respectively with the addressing level a0 and with the intermediate level ai.

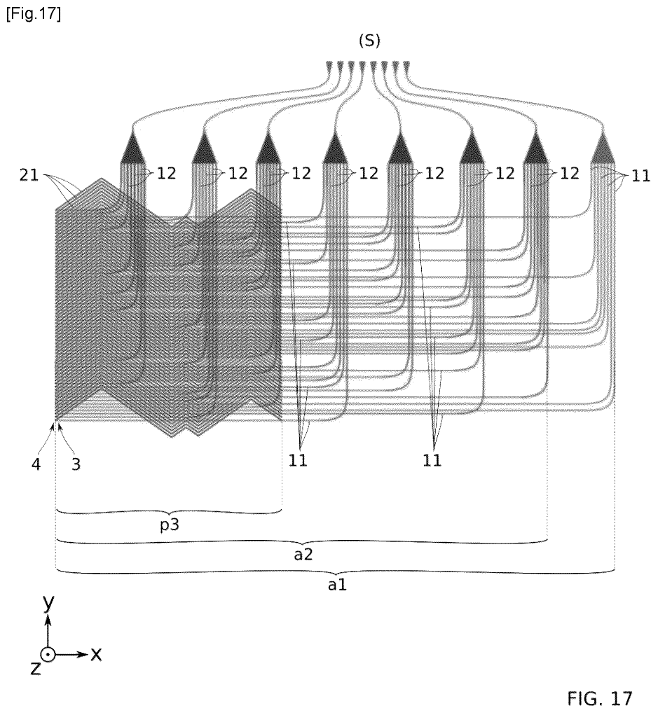

FIG. 17 illustrates a photonic projector architecture comprising two addressing or routing levels a1, a2, and a projection level p3. This makes it possible, from a few light sources (S), to address emission points distributed arbitrarily over the surface of a retinal projector, the guides 21 of which have “zigzag” shapes to give a random distribution to the emission points. The routing part comprises waveguides 11, 12 respectively on two levels, to avoid the guide intersections. This makes it possible to limit the optical losses. The projection part is located on a third level. The retro-coupling device 3, 4 makes it possible to advantageously superpose the projection level p3 on the addressing levels a1, a2.

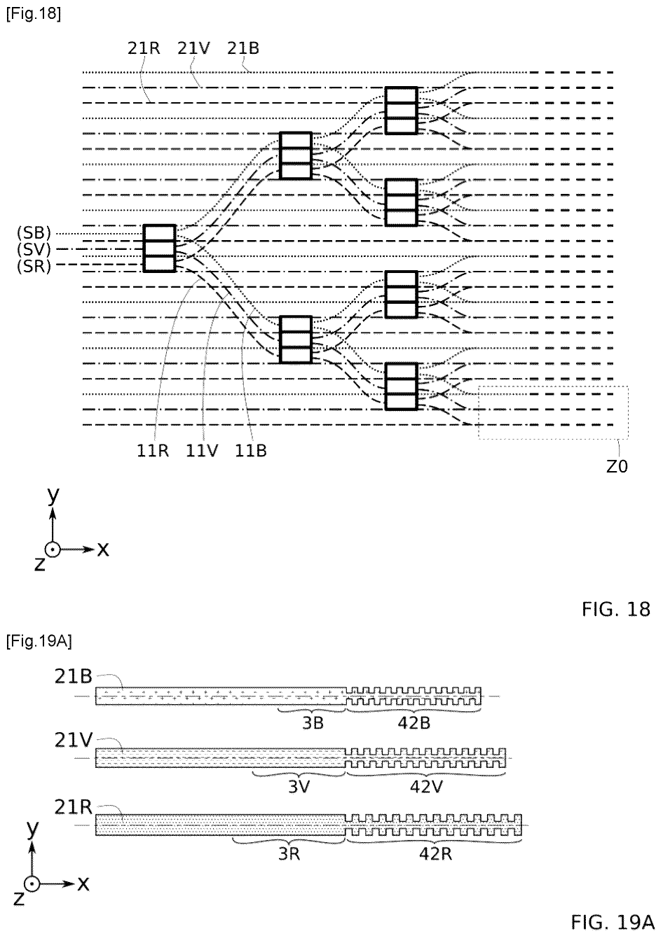

FIG. 18 illustrates a so-called RGB (Red Green Blue) multilevel retro-coupling device, comprising sublevels dedicated to light radiations of different wavelengths (for example, red, green, blue). This device typically comprises waveguides 11R configured to guide a first wavelength λ1 (for example, λ1=633 nm), waveguides 11V configured to guide a second wavelength λ2 (for example, λ2=532 nm), and waveguides 11B configured to guide a third wavelength λ3 (for example, λ3=450 nm). The waveguides 11R, 11V, 11B are typically located on different levels. The device further comprises waveguides 21R, 21V, 21B respectively configured to guide the first, second and third wavelengths λ1, λ2, λ3. The waveguides 21R, 21V, 21B are typically located on the same level, for example, a projection level of an RGB projector.

The different light radiations guided by the waveguides 11R, 11V, 11B are propagated by retro-coupling in the waveguides 21R, 21V, 21B. The zone ZO illustrated in FIG. 18 corresponds to this retro-coupling zone.

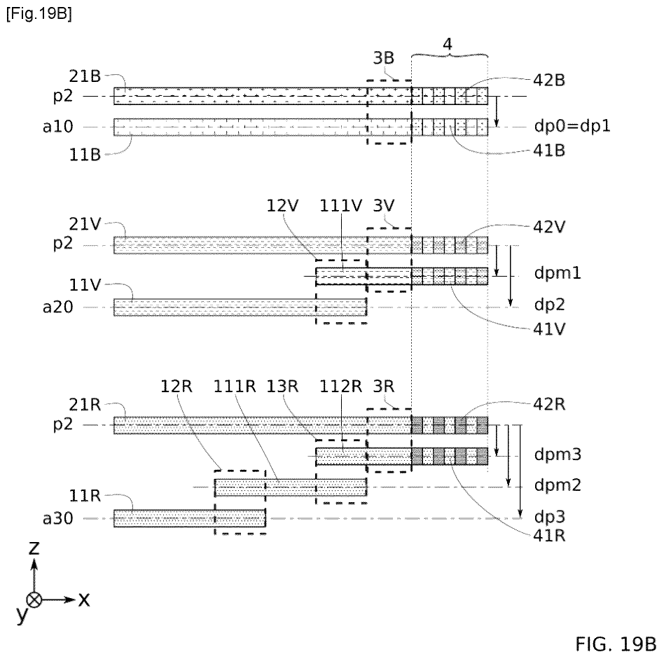

FIGS. 19A and 19B illustrate, in a more detailed manner, this retro-coupling zone. The waveguides 11R, 21R configured to guide the wavelength λ1 are typically sized differently from the waveguides 11V, 21V configured to guide the wavelength λ2, and differently from the waveguides 11B, 21B configured to guide the wavelength λ3. The retro-couplers are thus specific to the different wavelengths λ1, λ2, λ3. The guides 11R, 21R have a coupling portion 3R and a reflector 41R, 42R. The guides 11V, 21V have a coupling portion 3V and a reflector 41V, 42V. The guides 11B, 21B have a coupling portion 3B and a reflector 41B, 42B.

The shorter the wavelength is, the more the propagation mode of the corresponding light radiation is confined within the guide. Thus, for an effective coupling, the separation distance along z between the guides 11B, 21B is relatively shorter than the separation distance along z between the guides 11V, 21V, and the separation distance along z between the guides 11V, 21V is relatively shorter than the separation distance along z between the guides 11R, 21R. Thus, the addressing level a30 comprising the guides 11R is the deepest with respect to the projection level p2 comprising the guides 21R. The addressing level a10 comprising the guides 11B is the shallowest with respect to the projection level p2 comprising the guides 21B. The addressing levels a30, a20, a10 respectively have depths dp3, dp2, dp1 with respect to the projection level p2, such that dp3>dp2>dp1.

According to an option, the deepest addressing levels a30, a20 can resort to guide portions of intermediate depths to route the light radiation to the projection level p2.

As illustrated in FIG. 19B, the guide 11V of the addressing level a20 can first be coupled to a guide portion 111V of intermediate depth dpm1. A vertical coupling bridge 12V thus makes it possible for the light radiation of wavelength A2 to pass from the guide 11V to the guide portion 111V, then to be injected into the guide 21V by retro-coupling via the coupling portion 3V and the reflectors 41V, 42V.

The guide 11R of the addressing level a30 can first be coupled to a guide portion 111R of intermediate depth dpm2. This guide portion 111R can also be coupled to a guide portion 112R of intermediate depth dpm3. Two vertical coupling bridges 12R, 13R thus make it possible for the light radiation of wavelength A1 to pass from the guide 11R to the guide portion 112R, then to be injected into the guide 21R by retro-coupling via the coupling portion 3R and the reflectors 41R, 42R. The different guide levels and guide portions can thus form stairs to optimise the coupling and/or to limit the optical losses. According to an option, dpm2=dp2 and dpm3=dpm1=dp1. The different guide levels and guide portions are thus easier to produce by depositions and structuring of successive layers.

In view of the description above, it clearly appears that the device and the system proposed offer a particularly effective solution to improve the compactness of an integrated photonic system. The invention is not limited to the embodiments described above.

1. A multilevel retro-coupling device for a light radiation, comprising at least one first level (n1) extending along a first plane (xy1) and a second level (n2) extending along a second plane (xy2) parallel to the first plane (xy1), said first and second levels being at least partially superposed in a direction (z) normal to the first and second planes (xy1, xy2), the first level comprising at least one first waveguide configured to guide a propagation of the light radiation in a first direction (s1) and the second level comprising at least one second waveguide configured to guide the propagation of the light radiation in a second direction (s2) opposite the first direction, the device comprising:
a coupling portion, wherein the first and second waveguides are coupled by moving them closer to one another, such that the light radiation is propagated from the first level (n1) to the second level (n2) by evanescent coupling, and
at least one reflector at an end of the coupling portion, configured to reflect the light radiation.

2. The device according to claim 1, wherein the reflector is formed by an interruption of the first and second waveguides in a plane (xz) normal to the first and second propagation directions (S1, S2).

3. The device according to claim 1, wherein the reflector is formed by a block interrupting the first and second waveguides, said block being based on a reflective material, such as aluminium.

4. The device according to claim 1, wherein the coupling portion has a length L=Lc/2 in a propagation direction of the light radiation, Lc being the characteristic coupling length for a transfer of a propagation mode of the light radiation from the first waveguide to the second waveguide.

5. The device according to claim 1, wherein the reflector is formed by a first Bragg mirror coupled to the first waveguide and by a second Bragg mirror coupled to the second waveguide, said first and second Bragg mirrors being superposed in the normal direction (z).

6. The device according to claim 5, wherein the coupling portion has a length L=Lc/2−δ in a propagation direction of the light radiation, Lc being the characteristic coupling length for a transfer of a propagation mode of the light radiation from the first waveguide to the second waveguide, and δ>0 being a penetration length of the mode in the first and second Bragg mirrors.

7. An optical projection system comprising a multilevel retro-coupling device according to claim 1, wherein the second level (n2) corresponds to a projection level (p2), said system further comprising an electrode, called lower electrode, below the projection level (p2).

8. The system according to claim 7, wherein the first level (n1) corresponds to an addressing level (a1) and the lower electrode is located below the addressing level (a1).

9. The system according to claim 7, wherein the first level (n1) corresponds to an addressing level (a1) and the lower electrode is located between the projection level (p2) and the addressing level (a1).

10. The system according to claim 7, wherein the first level (n1) corresponds to an intermediate level (ai) and the lower electrode is located at the same level (n1) as the intermediate level (ai), the system further comprising an addressing level (a0) located below the lower electrode and the intermediate level (ai).

11. The system according to claim 7, wherein the at least one first level (n1) comprises a first addressing level (a10) comprising waveguides configured to guide a propagation of a first light radiation having a first wavelength λ1, a second addressing level (a20) comprising waveguides configured to guide a propagation of a second light radiation having a second wavelength λ2, a third addressing level (a30) comprising waveguides configured to guide a propagation of a third light radiation having a third wavelength λ3, and wherein the projection level (p2) comprises waveguides configured to respectively guide the propagations of the first, second and third light radiations, said first, second and third addressing levels (a10, a20, a30) being located at different depths dp1, dp2, dp3 with respect to the projection level (p2) in the normal direction (z).

12. The system according to claim 11, wherein λ3×λ2>λ1, and dp3>dp2>dp1.

13. The system according to claim 1, wherein the reflector comprises at least one first Bragg mirror configured to reflect the first wavelength λ1, at least one second Bragg mirror configured to reflect the second wavelength λ2, and at least one third Bragg mirror configured to reflect the third wavelength λ3, said first, second and third Bragg mirrors being located at one same depth dp0 with respect to the projection level (p2) in the normal direction (z), and wherein the waveguides of the first, second and third addressing levels (a10, a20, a30) are optically connected to the first, second and third Bragg mirrors by least one guide portion of intermediate depth dpmi (i=1 . . . 3) such that dp3>dpmi≥dp0.

14. The system according to claim 13, wherein the waveguides of the first addressing level (a10) are coupled to the at least one first Bragg mirror without guide portion of intermediate depth and dp1 32 dp0, the waveguides of the second addressing level (a20) are connected to the at least one second Bragg mirror by a guide portion of intermediate depth dpm1=dp0, the waveguides of the third addressing level (a30) are connected to the at least one third Bragg mirror by a guide portion of intermediate depth dpm2=dp2 and by a guide portion of intermediate depth dpm3=dp0.
